(19) United States
(12) Patent Application Publication
(10) Pub. No.: US 2019/0259117 A1
(43) Pub. Date: Aug. 22, 2019

(54) DYNAMICALLY RECONFIGURABLE SERVICE FOR HANDLING A SITUATION

(71) Applicant: Telefonaktiebolaget LM Ericsson (publ), Shockholm (SE)

(72) Inventors: Swarup Kumar MOHALIK, Marathahalli, Bangalore (IN); Sai CHANDRASEKAR, Chennai (IN); Shivashankar SUBRAMANIAN, Chennai (IN)

(73) Assignee: Telefonaktiebolaget LM Ericsson (publ), Shockholm (SE)

(21) Appl. No.: 16/335,034

(22) PCT Filed: Sep. 21, 2016
(86) PCT No.: PCT/IN2016/050317

§ 371 Date: Mar. 20, 2019

(51) Int. Cl. G06Q 50/26; G06Q 10/10; G08B 21/18

(52) U.S. Cl. CPC G06Q 50/265; G08B 21/18; G06Q 10/103

(57) ABSTRACT

The present disclosure relates to a method performed in a communication network (1). The method comprises receiving a trigger message a) indicating that a situation (4) has occurred. The trigger message comprises situation specific information. The method also comprises, based on the received situation specific information, configuring a service for handling the situation during a period of time until a predefined goal has been achieved. The service includes a plurality of partially-ordered tasks to be performed and a plurality of stakeholders (3). The tasks are parameterized with entities and the stakeholders. The method also comprises, during the period of time, as part of the service, sending updated information c) about the tasks to the stakeholders. The method also comprises, in response to the information sent, receiving input d) about the tasks from the stakeholders. The method also comprises, in response to the received input, automatically and dynamically reconfiguring the service, including updating the information about the tasks, until the predefined goal has been achieved.

### TECHNICAL FIELD

The present disclosure relates to a method and devices for handling a situation by means of a service.

### BACKGROUND

In case of a medical emergency situation involving a person, a number of tasks are to be performed to ultimately bring the person and the environment to a normal state. These involve first-aid, getting an ambulance with the right amenities, informing the hospital(s) with right capabilities, informing the relatives and close friends, informing the traffic and fire department etc. During the planning and execution of these tasks, re-planning may occur due to unforeseen changes. The stake-holders performing the different tasks must be synchronized on the state of the person and environment. This is necessary to ensure that all the tasks are executed properly and to ensure that tasks are not unnecessarily duplicated. From a human point of view, this provides assurance and psychological comfort to the stakeholders that the right things are being done to take care of the emergency situation.

Emergency services like 911 can handle some of the requirements like informing the police, hospitals and traffic/fire department. But a number of tasks such as a finding the relatives is a manual task. Also the synchronization aspect is a manual task and hence the stakeholders are dependent upon the expertise of a coordinator.

### SUMMARY

There exist technical solutions for some of the tasks, such as finding a nearby ambulance, detecting a medic in the proximity, informing the police, traffic, fire, ambulance. But there is no system that provides a comprehensive view of the situation and the complete plan to handle the situation. There is also no platform which allows all the stakeholders to synchronize and where various stakeholders can communicate and agree on handling tasks and subtasks. There is no method for interactively assigning tasks/subtasks to execute the plan.

Thus, an objective of the present disclosure is to provide a communication network comprising a service, e.g. a software service, for improving coordination between stakeholders as well as keeping track of tasks being performed and ensuring that they are indeed performed, until a goal is achieved, e.g. a person in need of medical attention has successfully been delivered to a suitable hospital.

According to an aspect of the present application, there is provided a method performed in a communication network. The method comprises receiving a trigger message indicating that a situation has occurred. The trigger message comprises situation specific information. The method also comprises, based on the received situation specific information, configuring a service for handling the situation during a period of time until a predefined goal has been achieved. The service includes a plurality of partially-ordered tasks to be performed and a plurality of stakeholders. The tasks are parameterized with entities and the stakeholders. The method also comprises, during the period of time, as part of the service, sending updated information about the tasks to the stakeholders. The method also comprises, in response to the information sent, receiving input about the tasks from the stakeholders. The method also comprises, in response to the received input, automatically and dynamically reconfiguring the service, including updating the information about the tasks, until the predefined goal has been achieved.

According to another aspect of the present application, there is provided a computer program product comprising computer-executable components for causing a communication network to perform an embodiment of the method of the present disclosure when the computer-executable components are run on processing circuitry comprised in the communication network.

According to another aspect of the present application, there is provided a communication network comprising processing circuitry, and storage storing instructions executable by said processing circuitry whereby said communication network is operative to receive a trigger message indicating that a situation has occurred, the trigger message comprising situation specific information. The communication network is also operative to, based on the received situation specific information, configure a service for handling the situation during a period of time until a predefined goal has been achieved, the service including a plurality of partially-ordered tasks to be performed and a plurality of stakeholders, the tasks being parameterized with entities and the stakeholders. The communication network is also operative to, during the period of time, as part of the service, send updated information about the tasks to the stakeholders. The communication network is also operative to, in response to the information sent, receive input about the tasks from the stakeholders. The communication network is also operative to, in response to the received input, automatically and dynamically reconfigure the service, including updating the information about the tasks, until the predefined goal has been achieved.

According to another aspect of the present application, there is provided a computer program comprising computer program code which is able to, when run on processing circuitry of a communication network, cause the communication network to receive a trigger message indicating that a situation has occurred, the trigger message comprising situation specific information. The code is also able to cause the communication network to, based on the received situation specific information, configure a service for handling the situation during a period of time until a predefined goal has been achieved, the service including a plurality of partially-ordered tasks to be performed and a plurality of stakeholders, the tasks being parameterized with entities and the stakeholders. The code is also able to cause the communication network to, during the period of time, as part of the service, send updated information about the tasks to the stakeholders. The code is also able to cause the communication network to, in response to the information sent, receive input about the tasks from the stakeholders. The code is also able to cause the communication network to, in response to the received input, automatically and dynamically reconfigure the service, including updating the information about the tasks, until the predefined goal has been achieved.

According to another aspect of the present application, there is provided a computer program product comprising an embodiment of the computer program of the present disclosure and a computer readable means on which the computer program is stored.

By means of embodiments of the present disclosure, problems in the prior art are solved. Specifically, the service provider associated with a communication network configures a service (herein also called an agent or software service) in the communication network when it is first triggered by a signal indicating that a situation, e.g. an emergency such as a medical emergency, has occurred. The detection of the situation may be done through existing methods.

The agent may start with a template of tasks designed for the type of situation, e.g. medical emergencies, and starts pruning/populating the tasks and subtasks thereof. Then, the agent may assign the tasks to the different stakeholders (e.g. ambulance, medical professionals, relatives etc.). A task may also be the determining of some of the stakeholders themselves.

The agent may assign some of the tasks to some stakeholders, but for other tasks it may open up a board and ask for volunteers among the stakeholders. After assigning the tasks to stakeholders, the agent may continuously monitor the performing of the tasks through to their respective completion in order to ensure that they are completed as required.

In case of failure to complete a task, as indicated by state of the environment and stakeholders, re-planning may be done by the agent, which may include manual intervention, and another round of task assignment may be performed.

Depending upon the type of the stakeholders, filters may be defined so that each stakeholder gets only the information about tasks relevant for that stakeholder. In case a stakeholder does not agree with the plan of tasks, it may intervene for a re-plan. This may be evaluated and incorporated in the current plan after feasibility/optimality has bee considered.

Embodiments of the present disclosure may present any of the following advantages:
The execution of the task plan by the agent ensures a suitable handling of the occurred situation.
All required tasks are assigned to a suitable stakeholder, coordinated and monitored during the handling of the situation, until a predefined goal has been achieved. The path from the task to the root task in the partial order provides the justification as to why the task should be carried out.
All stakeholders have insight into the task plan to handle the situation and are able to suggest updates of the plan and tasks therein.
The insight of the stakeholders may be based on the individual, customized requirements by means of filtering of task information.
The task plan adapts dynamically to the changes in the environment and the changes and justifications may be visible to the stakeholders.
The planning and execution by the agent gives assurance to the stakeholders that the situation is being handled in a suitable manner.

It is to be noted that any feature of any of the aspects may be applied to any other aspect, wherever appropriate. Likewise, any advantage of any of the aspects may apply to any of the other aspects. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1 is a schematic block diagram illustrating an embodiment of a communication network and its communication interfaces, in accordance with the present disclosure.

FIG. 2 is a schematic flow chart of an embodiment of the method in accordance with the present disclosure.

FIG. 3 is a schematic functional diagram of an embodiment of the communication network in accordance with the present disclosure.

FIG. 4 schematically illustrates an embodiment of partially-ordered tasks, in accordance with the present disclosure.

FIG. 5a is a schematic block diagram of an embodiment of a communication network in accordance with the present disclosure.

FIG. 5b is a schematic functional block diagram of an embodiment of the communication network in accordance with the present disclosure.

FIG. 6 schematically illustrates an embodiment of a computer program product in accordance with the present disclosure.

FIG. 7 is a schematic signalling diagram of example embodiments of the method in accordance with the present disclosure.

### DETAILED DESCRIPTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

It is herein proposed a service may include the following features:
The service maintains an inventory of stakeholders and tasks to be carried out in case of a situation of a certain type, e.g. medical emergency, occurring.
It informs the respective stakeholder about relevant parts of the task inventory.
It reconfigures itself in view of new or changed tasks or subtasks thereof.
It provides a platform for stakeholders to volunteer for tasks or to assign tasks to other stakeholders.
It monitors the progress of the execution of the tasks and communicates regularly with the stakeholders.
It provides re-planning of the tasks, e.g. when there are unforeseen changes in the environment.

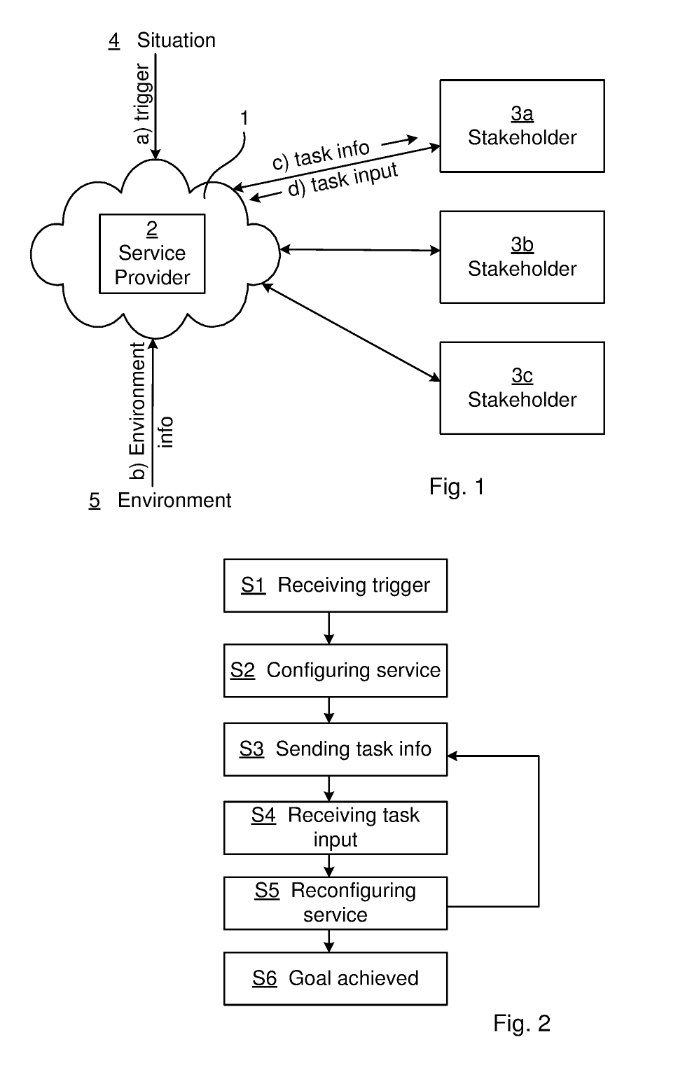

FIG. 1 schematically illustrates an embodiment of a communication network 1, e.g. in a cloud, comprising a service provider 2, typically in the form of data servers of the service provider, for providing the service/agent, e.g. software service, discussed herein. The communication network, e.g. the service provider, comprises a communication interface for exchanging communication signals with entities external to the communication network. In accordance with the present disclosure, the communication network may receive a trigger message a) indicating that a situation 4 has occurred. The communication network may also receive environment information (info) b) about the environment 5 relevant to the situation 4 or to the performance of the tasks, e.g. weather and/or traffic information. The communication network 1 also communicates with a plurality of stakeholders 3, here three stakeholders 3a, 3b and 3c are shown as an example, e.g. medic(s) and ambulance(s) in case of a medical emergency situation 4. To each of the stakeholders, task information c) may be sent, and in response, from each of the stakeholders, task input d) may be received.

FIG. 2 is a flow chart illustrating embodiments of the method performed in the communication network 1, of the present disclosure. A trigger message a) indicating that a situation 4 has occurred is received Si. The trigger message comprises situation specific information, e.g. what has happened (type of situation), who is involved etc. Then, based on the received Si situation specific information, a service is configured S2 for handling the situation 4 during a period of time until a predefined goal has been achieved. The service includes a plurality of partially-ordered tasks to be performed and a plurality of stakeholders 3. The tasks are parameterized with entities and the stakeholders. During the period of time, as part of the service, updated information c) about the tasks is sent S3 to the stakeholders 3. In response to the task information sent S3, input d) about the tasks is received S4 from the stakeholders 3. In response to the received S4 input, the service is automatically and dynamically reconfigured S5, including updating the information c) about the tasks, until the predefined goal has been achieved S6. The updated task information c) may then be sent S3 to the stakeholders 3, the steps of sending S3 task info, receiving S4 task input and reconfiguring S5 the service/agent being repeated as needed until the goal (e.g. get patient to a suitable hospital) has been achieved S6.

An example of a parameterized task is given by the task navigate(amb_driver, amb, amb_location, destination) which has four parameters. In this case, all the parameters are variables and they can be instantiated (making them constants) during the execution of the task. The amb_driver is a stakeholder 3—the person who is responsible for driving the ambulance, the ambulance amb, amb_location and destination are instantiated by the (concrete) entities or things during execution. We can consider locations as entities because each place is associated with a concrete value (name or latitude-longitude).

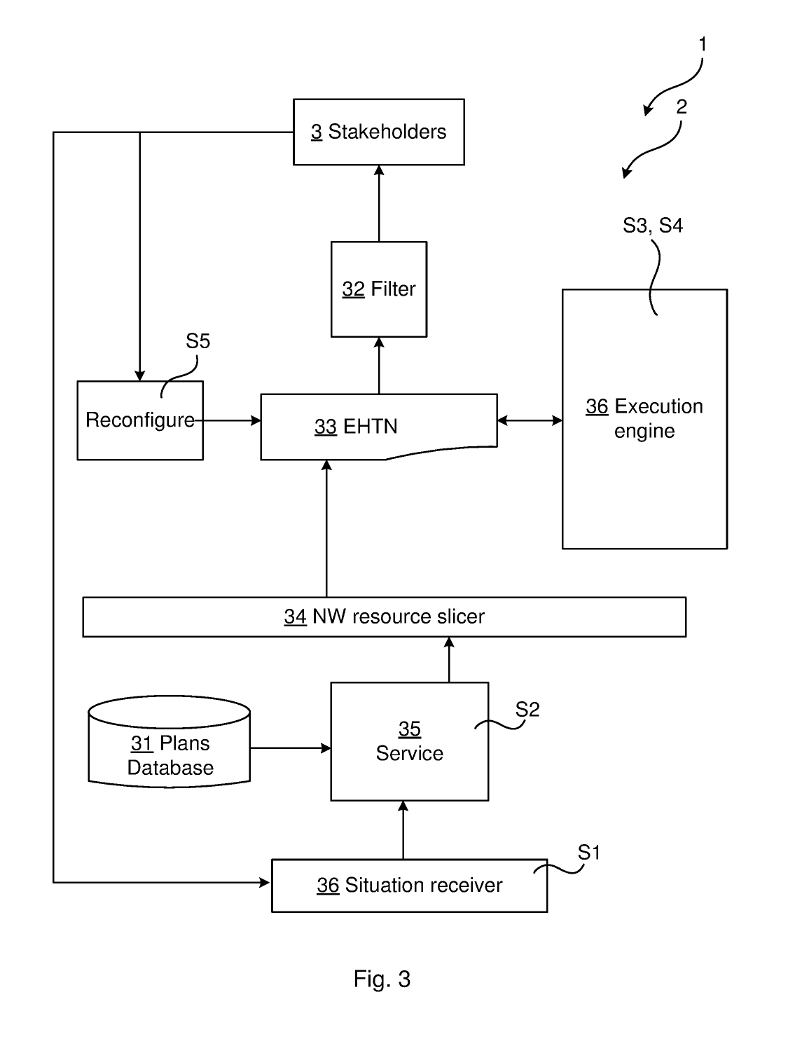

FIG. 3 illustrates example embodiments of the present disclosure, including modules which may be formed in the communication network 1 by the service provider 2 in order to perform the method of the present disclosure.

A situation receiver 36 receives Si a trigger message a), e.g. an emergency signal, comprising situation information, e.g. the type of emergency, person(s) involved, phone number (if available), location of the occurred situation 4, time of the occurrence and/or known details of the persons involved. The service 35 is configured S2 and the situation information is inputted there to.

The receiver 36 may also receive messages from stakeholders 3 regarding instantiation values, possibly different plan implementation etc. and applies appropriate action on the task network.

Example: the receiver 36 receives Si an emergency signal that says emergency type is health-related, possible heart attack, in a car. The afflicted person is John, his phone is 9945698671, location is Marathahalli bridge (Latitude=38.03, Longitude=80.00), 12:00 pm, he is allergic to peanuts and cats, the car registration number is KA03-8885.

Extended Hierarchical Task Network (EHTN) 33 is a network of possibly parametrized tasks with dependency links between tasks. Each task may be in different states, e.g. not_assigned/assigned, not_started/in_progress/completed, etc. When the network i receives Si the signal for emergency, an appropriate task network including a plurality of partially-ordered predefined tasks suitable for the type of situation 4 may be retrieved from a plans database 31, which task network 33 may be a central data structure which may be updated by the stakeholders 3 and in view of the environment 5.

A network (NW) resource slicer 34 assigns NW resources of the communication network i to the EHTN 33.

Each task in the network 33 can be another network or an atomic task. The planning operation may then flatten the entire network to atomic tasks.
Example: find_proximal_medics(location), find_ambulance(health_condition, location, amb, amb_location)→navigate_ambulance(amb, amb_location, location), find_details(name, phone no, car), inform_hospital(health_condition, location, health_constraints), find_relatives(name, phone no, rel_location).

The task Find_ambulance finds an ambulance from the appropriate stakeholder 3 (emergency service), with the facilities for the health_condition, and also its location.

The task Navigate_ambulance(amb, location1, location2) may be divided into the subtasks Get_route(vehicle_type(amb), location1, location2, route)→turn-by-turn(amb, route)

Navigate ambulance is a composite task which is broken into atomic tasks get_route and turn_by_turn.

The parametrized tasks may be instantiated (assigned a value, illustrated by hard brackets herein) by default stakeholder and available information. The instantiations can be changed during the execution stage. The tasks that are not fully instantiated may be marked uninstantiated. If a stakeholder is needed for performing a task, e.g. an actor parameter of the task is not instantiated, a request for a stakeholder to take care of the task may be broadcasted. Some of the information may be mandatory and hence the seek tasks must be assigned and executed. Some of the seek tasks may only be desirable, and hence can be de-prioritized in case of e.g. resource conflict.

Example: find_proximal_medics([Internet Service Provider], Marathahalli bridge(Latitude=38.03, Longitude=80.00)),
find_ambulance([emergency services], [heart attack], Marathahalli bridge(Latitude=38.03, Longitude=80.00), amb, amb_location)→
navigate_ambulance([agent], amb, amb_location, Marathahalli bridge(Latitude=38.03, Longitude=80.00)),
find_details([police], [name, John], [phone, 9945698671], [car, KA038885]),
inform_hospital([hospital service] [heart_attack], Marathahalli bridge(Latitude=38.03, Longitude=8 0.00), [allergy, [peanut, cat's hair]], hospital_instance),
find_relatives([police], [name, John], [phone, 9945698671], rel_location).
navigate_ambulance([agent], amb, Marathahalli bridge(Latitude=38.03, Longitude=80.00), hospital_instance).

When a task is instantiated and does not have any dependency, it may be triggered for execution by the execution engine 36 and be marked in_progress. Task information c) is sent S3 to the stakeholder/actor responsible for performing the task. When a task is completed, the stakeholder 3 signals the network 1 (task input d) is received S4) and the task may be marked completed in response thereto. This then leads to the performance of a subsequent, dependent tasks if any.

Example: After find_ambulance task succeeds, we have an ambulance (amb) and its location (amb_location). The next task navigate ambulance gives turn-by-turn signals to the ambulance on the fastest route to the emergency location and first-aid treatment to the afflicted person.

Reconfiguring S5: If a task fails to complete, or does not meet a deadline, then a new task (may be an instance of the failed task) may be initiated depending upon the current conditions. The new task may alternatively be suggested by the stakeholder 3, in which case the proposed task may be evaluated to either match the goal of the earlier task or the entire task network 33 is checked to see if the proposed task leads to the final goal in view of any cascading impact on other tasks.

Example: During the turn-by-turn task, if there is a traffic jam on the way (as indicated by environmental information b), the system does a reconfiguring S5 to get a new route (and hence the turn sequence) since it calculates that the Estimated Time of Arrival (ETA) to the hospital will otherwise not be met.

Assume that the find_relatives( ), does not find any close relative. The communication network 1 may then reconfigure S5 the service to find a friend instead (using a service—which might mine e.g. social media to find a friend).

Suppose there is a task of inform_insurance([informer], [insurance-agent], person).

The details of the afflicted person may be used to find his/her insurance agent through a subtask.

The wife for instance may volunteer for this task when the to-be-decided (TBD) task Inform_insurance([informer], INSURANCE-AGENT, PERSON) is displayed. Then, the task is instantiated to Inform_insurance(wife, INSURANCE-AGENT, PERSON).

Responsibility Zone and Information filter 32: Each stakeholder 3 may have a set of parameters called the responsibility zone. The tasks depending upon and affecting these parameters form a filter 32 for the stakeholder. These tasks and their state during execution may be communicated to the stakeholders in real-time. The need for real-time may be due to the emergency situation.

Example: The hospital stakeholder 3 is interested in the health-condition, time_elapsed, allergy information and drug restrictions. It does not need the position of the ambulance, so the navigation information is filtered out from the information c) sent S3 to the hospital.

The police is interested in the transport part, hence the traffic details and ambulance positions are included in the task information c) sent S3 to the police.

The wife may be interested in the capability of the hospital (can it handle cardiac patients) and ambulance position. Thus, the information c) defined by the filter 32 for the wife is configured accordingly. If the wife is not happy with the hospital/doctor and suggests another hospital in task input d) received S4 by the network 1, the suggested hospital is evaluated based on the hospital service and the time needed for the ambulance to reach the new hospital. If feasible, the service 35/EHTN 33 of the service is reconfigured S5 accordingly.

NW resource slicer 34 may, as mentioned above, be a component in the communication network 1 that includes cloud and network resource provisioning to ensure the real-time and guaranteed Quality of Service (QoS) requirements of the service 35. This may be created for the entire task network 33 or for each task or for a subset of related tasks.

When a stakeholder 3 suggests a new task and it is evaluated to be feasible, it may be added to the plans database 31 for future use with the situation type.

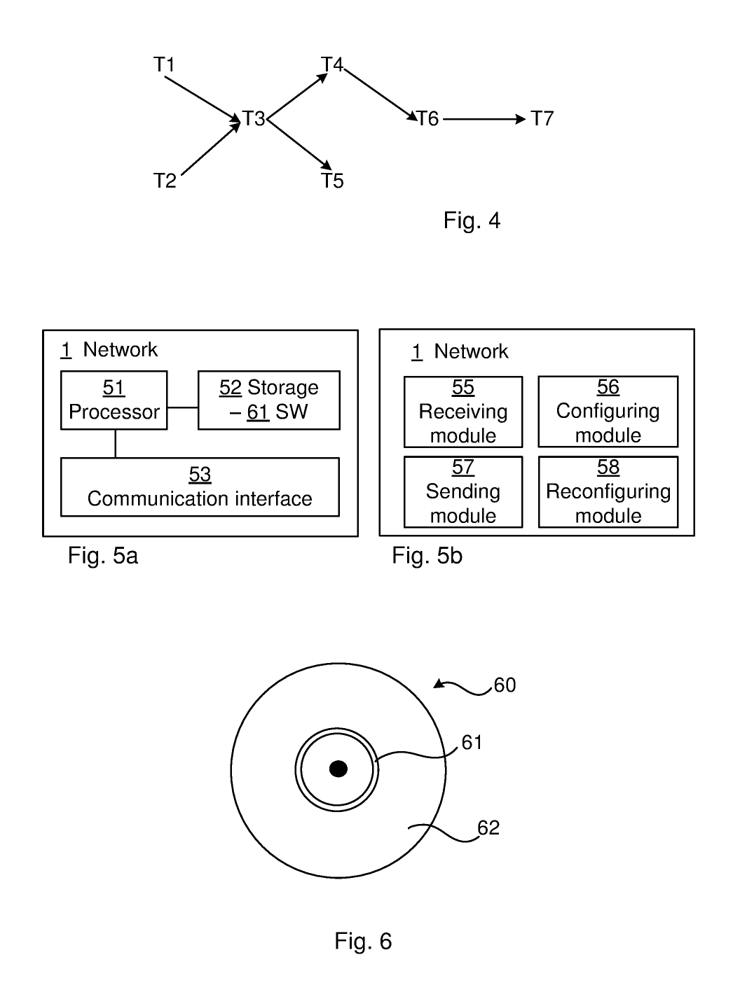

FIG. 4 illustrates the concept of partially ordered tasks T, e.g. in contrast to sequentially ordered tasks. Here, The tasks T1 and T2 can start independently, when both of them finish, task T3 can start. After T3 finishes, both tasks T4 and T5 can start. After T4 is finished, task T6 and then task T7 can start. Partially ordered tasks allow concurrent execution, not only sequential execution.

FIG. 5a schematically illustrates an embodiment of a communication network 1, e.g. of a service provider 2, of the present disclosure. The communication network 1 comprises processing circuitry 51 e.g. a central processing unit (CPU). The processing circuitry 51 may comprise one or a plurality of processing units in the form of microprocessor(s). However, other suitable devices with computing capabilities could be comprised in the processing circuitry 51, e.g. an application specific integrated circuit (ASIC), a field programmable gate array (FPGA) or a complex programmable logic device (CPLD). The processing circuitry 51 is configured to run one or several computer program(s) or software (SW) 61 (see also FIG. 6) stored in a storage 52 of one or several storage unit(s) e.g. a memory. The storage unit is regarded as a computer readable means 62 (see FIG. 6) as discussed herein and may e.g. be in the form of a Random Access Memory (RAM), a Flash memory or other solid state memory, or a hard disk, or be a combination thereof.

The processing circuitry 51 may also be configured to store data in the storage 52, as needed. The communication network 1 also comprises a communication interface 53 e.g. for receiving S1, S4 the trigger a), any environmental information b) and task input d) from the stakeholders 3, as well as for sending S3 the task information c).

According to an aspect of the present application, there is provided a communication network 1 comprising processing circuitry 51, and storage 52 storing instructions 61 executable by said processing circuitry whereby said communication network is operative to receive a trigger a) message indicating that a situation 4 has occurred, the trigger message comprising situation specific information. The communication network is also operative to, based on the received situation specific information, configure a service 35 for handling the situation during a period of time until a predefined goal has been achieved, the service including a plurality of partially-ordered tasks T to be performed and a plurality of stakeholders 3, the tasks being parameterized with entities and the stakeholders. The communication network is also operative to, during the period of time, as part of the service, send updated information c) about the tasks to the stakeholders. The communication network is also operative to, in response to the information sent, receive input d) about the tasks from the stakeholders. The communication network is also operative to, in response to the received input, automatically and dynamically reconfigure the service, including updating the information about the tasks, until the predefined goal has been achieved.

FIG. 5b is a schematic block diagram functionally illustrating an embodiment of the communication network 1 in FIG. 5a. As previously mentioned, the processing circuitry 51 may run software 61 for enabling the communication network 1 to perform an embodiment of a method of the present disclosure, whereby functional modules may be formed in communication network 1 e.g. in the processing circuitry 51 for performing the different steps of the method. These modules are schematically illustrated as blocks within the communication network 1. Thus, the communication network 1 comprises a receiving module 55 (for example associated with the communication interface 53, e.g. including the situation receiver 36) for receiving S1 the trigger message a) indicating that a situation 4 has occurred, the trigger message comprising situation specific information. The communication network 1 also comprises a configuring module 66 for, based on the received Si situation specific information, configuring S2 a service 35 for handling the situation during a period of time until a predefined goal has been achieved S6, the service including a plurality of partially-ordered tasks T to be performed and a plurality of stakeholders 3, the tasks being parameterized with entities and the stakeholders. The communication network 1 also comprises a sending module 57 (e.g. associated with the communication interface 53) for, during the period of time, as part of the service, sending S3 updated information c) about the tasks to the stakeholders 3. The receiving module 55 may also be for, in response to the information sent S3, receiving S4 input d) about the tasks T from the stakeholders. The communication network 1 also comprises a reconfiguring module 58 for, in response to the received input, automatically and dynamically reconfiguring S5 the service, including updating the information c) about the tasks, until the predefined goal has been achieved S6.

FIG. 6 illustrates an embodiment of a computer program product 60. The computer program product 60 comprises a computer readable (e.g. non-volatile and/or non-transitory) medium 62 comprising software/computer program 61 in the form of computer-executable components. The computer program 61 may be configured to cause a communication network 1, e.g. as discussed herein, to perform an embodiment of the method of the present disclosure. The computer program may be run on the processing circuitry 51 of the communication network 1 for causing it to perform the method. The computer program product 60 may e.g. be comprised in a storage unit or memory 62 comprised in the communication network 1 and associated with the processing circuitry 51. Alternatively, the computer program product 60 may be, or be part of, a separate, e.g. mobile, storage means/medium, such as a computer readable disc, e.g. CD or DVD or hard disc/drive, or a solid state storage medium, e.g. a RAM or Flash memory. Further examples of the storage medium can include, but are not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Embodiments of the present disclosure may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

According to an aspect of the present disclosure, there is provided a computer program product 60 comprising computer-executable components 61 for causing a communication network 1 to perform an embodiment of the method of the present disclosure when the computer-executable components are run on processing circuitry 51 comprised in the communication network 1.

According to another aspect of the present application, there is provided a computer program 61 comprising computer program code which is able to, when run on processing circuitry 51 of a communication network 1, cause the communication network to receive S1 a trigger message a) indicating that a situation 4 has occurred, the trigger message comprising situation specific information. The code is also able to cause the communication network to, based on the received S1 situation specific information, configure S2 a service 35 for handling the situation during a period of time until a predefined goal has been achieved, the service including a plurality of partially-ordered tasks T to be performed and a plurality of stakeholders 3, the tasks being parameterized with entities and the stakeholders. The code is also able to cause the communication network to, during the period of time, as part of the service, send S3 updated information c) about the tasks to the stakeholders. The code is also able to cause the communication network to, in response to the information sent S3, receive S4 input d) about the tasks from the stakeholders. The code is also able to cause the communication network to, in response to the received S4 input, automatically and dynamically reconfigure S5 the service, including updating the information c) about the tasks, until the predefined goal has been achieved S6.

According to another aspect of the present application, there is provided a computer program product 60 comprising an embodiment of the computer program 61 of the present disclosure and a computer readable means 62 on which the computer program is stored.

In some embodiments of the present disclosure, the received S4 input d) comprises an acknowledgement from at least one of the plurality of stakeholders 3, said acknowledgement indicating that the at least one stakeholder has accepted responsibility for performing at least one of the plurality of tasks T.

In some embodiments of the present disclosure, the received S4 input d) comprises a confirmation message from at least one of the plurality of stakeholders 3, the confirmation message comprising information confirming completion of at least one of the plurality of tasks T.

In some embodiments of the present disclosure, the received S4 input d) comprises a task message from at least one of the plurality of stakeholders 3, the task message comprising information about a new or amended task to be included in the plurality of tasks T. In some embodiments, the new or amended task is sub-task subdivided from a task of the plurality of tasks T. Additionally or alternatively, in some embodiments, the reconfiguring S5 comprises determining whether the new or amended task should be accepted or rejected (above discussed as whether it is feasible).

In some embodiments of the present disclosure, the situation 4 is an emergency situation and at least one of the plurality of stakeholders 3 is a medical professional. However, other types of situations 4 are also relevant with other embodiments of the present disclosure.

In some embodiments of the present disclosure, at least one of the entities is a location where the situation 4 has occurred and/or a location of one of the stakeholders 3.

In some embodiments of the present disclosure, the tasks T are also parameterized with environmental parameters for which the communication network 1 obtains environmental information b).

In some embodiments of the present disclosure, the sending S3 updated information c) comprises sending updated information about a first group of the plurality of tasks T to a first stake holder 3a and sending updated information about a second group (different from the first group) of the plurality of tasks T to a second stake holder 3b. In some embodiments, the first and second groups of the plurality of tasks T are defined by means of applying respective filters 32 for the first and second stake holders 3a and 3b.

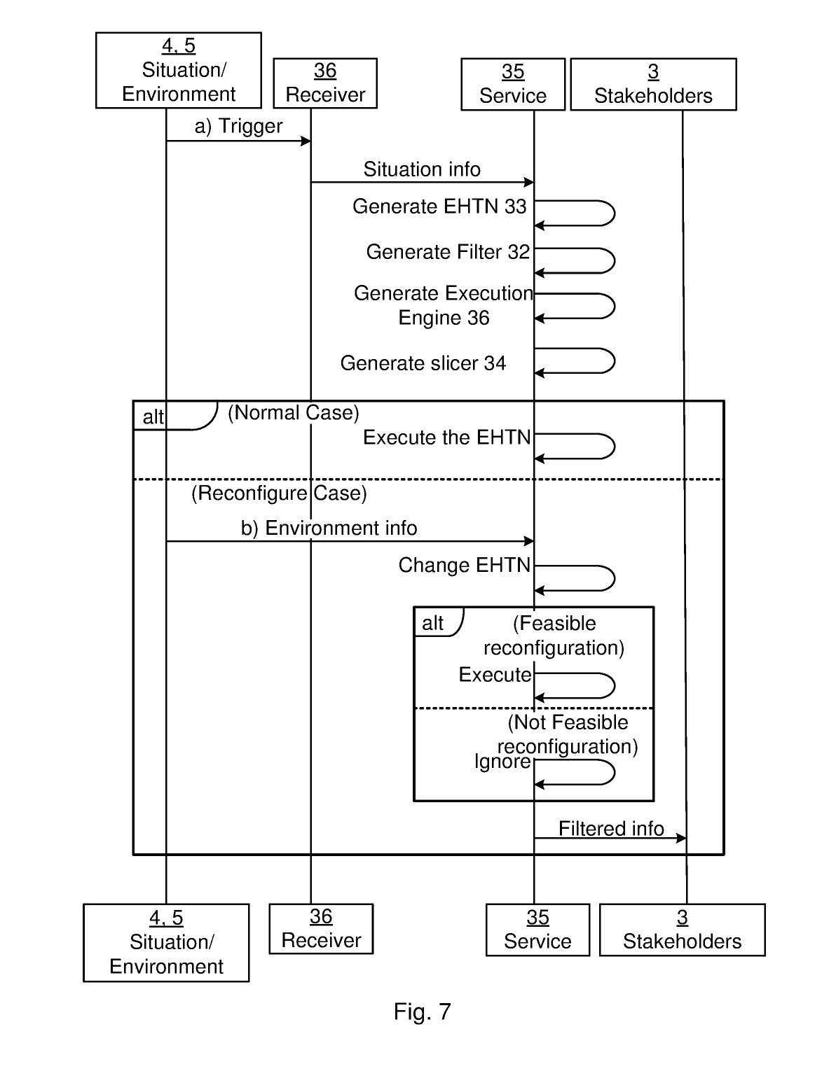

Above, the present disclosure has been related to the example of a medical emergency, but other embodiments of the present disclosure may be used for any other situation 4 which should be handled. Below follows e.g. an example relating to EHTN 33 for a water tank cleaning operation. The parameters are in normal letters. The values are in [ ], most values are instantiated for the parameters when the EHTN is executed. Reference is also made to FIG. 7, which is a general signalling diagram relevant also for other embodiments of the present disclosure.
Clean_tank(address, tank-details):

This trigger a) comprises situation specific information including value for the address and details of the tank which may include the shape/size/access method etc. e.g. derived from a detailed attribute list of water tanks. The situation specific information is used for configuring S2 the service/agent 35, which generates the EHTN 33, the filter(s) 32, the execution engine 36 and the slicer 34. The EHTN 33 may then be executed. Some of the tasks can be taken up concurrently, but for ease of presentation it is assumed that they are done sequentially. In view of task input d) from the stakeholders 3, or on environmental information b), the service may be reconfigured S5, whereby the EHTN is changed/updated in view thereof. The updating of the service and its EHTN 33 may depend on whether the changes due to environment info b) and/or input d) from stakeholder(s) 3 are determined to be feasible or not (if not, the changes may be ignored). Filtered updated task info c) relating to the reconfigured S5 service is then sent S3 to the stakeholders. Examples of the execution is given below.

Get_contact_owner(address, tank-details, owner)

// Clean_tank([RGB-612, PR Apartments, Bangalore-560037], [vol:2000, unit:liter,
shape:dome, access: [method:ladder, height:20, unit:ft]]) will instantiate the
address and tank details, and will also find the contact for the owner of the house.
The contact may be like [name: X, phone:Y, email:Z]

Get_contact_owner([ADDRESS], [TANK-DETAILS], [OWNER-CONTACT])
Publish([TANK-CLEANING], tank-details, address) −> Get_quotes([TANK-

CLEANING], tank-details, quotations)
//publishing the task with name TANK-CLEANING and the tank details and
address though a service may attract quotations from vendors. The details
instantiate the parameter “quotations” : list of [vendor, start time, duration
required, price, requirements - size of equipment, power inputs, disposal details -
final dumping place and route to be followed]

Negotiate(owner, civic_authority, quotations, final-quotation)

//The negotiate service itself may be a graph. It finds and instantiates the civic-
authority for the area mentioned in the [ADDRESS]. There is a publishing of the
details in the quotation for all the stakeholders, each one ticking the possible
choices. The service finds a feasible combinations and finalizes. For example, if the
civic authority ticks a far-away dumpling place, the price quoted by vendor would be
higher and the owner may not have ticked that range of prices, hence the
negotiation will fail.

The output is a final quotation - requirement of equipment should match with

availability in the compound. Involve civic-authority to allow dumping in specific
place and route to be followed. For example, main roads may not be allowed since
any leak may affect road safety.

Find_sludge_disposal([TANK-CLEANING], dumping_place)
Slice-inform(vendor, owner, civic-authority, quotation)

//Vendor and owner know about the cleaning and billing parts of the quotation,
civic-authority is informed about the time, dumpling place and route. This may be a
periodic task. Once it starts, it the filtered information to the stake-holder 3 in
regular intervals.

Navigate(vendor, address, time-of-cleaning) −> Tank-cleaning(vendor) −>
Dispose_sludge(vendor, address, dumping_place, route)

// the sub-graph for displose_sludge is as follows.
Dispose_sludge(vendor, address, dumping_place, route):

Navigate(vendor, address, route) −> Dump_sludge(dumpling_place)

The present disclosure has mainly been described above with reference to a few embodiments. However, as is readily appreciated by a person skilled in the art, other embodiments than the ones disclosed above are equally possible within the scope of the present disclosure, as defined by the appended claims.

1. A method performed in a communication network, the method comprising:
receiving a trigger message indicating that a situation has occurred, the trigger message comprising situation specific information;
based on the received situation specific information, configuring a service for handling the situation during a period of time until a predefined goal has been achieved, the service including a plurality of partially-ordered tasks to be performed and a plurality of stakeholders, the tasks being parameterized with entities and the stakeholders;
during the period of time, as part of the service, sending updated information about the tasks to the stakeholders;
in response to the information sent, receiving input about the tasks from the stakeholders; and
in response to the received input, automatically and dynamically reconfiguring the service, including updating the information about the tasks, until the predefined goal has been achieved.

2. The method of claim 1, wherein the received input comprises an acknowledgement from at least one of the plurality of stakeholders, said acknowledgement indicating that the at least one stakeholder has accepted responsibility for performing at least one of the plurality of tasks.

3. The method of claim 1, wherein the received input comprises a confirmation message from at least one of the plurality of stakeholders, the confirmation message comprising information confirming completion of at least one of the plurality of tasks.

4. The method of claim 1, wherein the received input comprises a task message from at least one of the plurality of stakeholders, the task message comprising information about a new or amended task to be included in the plurality of tasks.

5. The method of claim 4, wherein the new or amended task is sub-task subdivided from a task of the plurality of tasks.

6. The method of claim 4, wherein the reconfiguring comprises determining whether the new or amended task should be accepted or rejected.

7. The method of claim 1, wherein the situation is an emergency situation and at least one of the plurality of stakeholders is a medical professional.

8. The method of claim 1, wherein at least one of the entities is a location where the situation has occurred and/or a location of one of the stakeholders.

9. The method of claim 1, wherein the tasks are also parameterized with environmental parameters for which the communication network obtains environmental information.

10. The method of claim 1, wherein the sending updated information comprises sending updated information about a first group of the plurality of tasks to a first stake holder and sending updated information about a second group of the plurality of tasks to a second stake holder.

11. The method of claim 10, wherein the first and second groups of the plurality of tasksare defined by means of applying respective filters for the first and second stake holders.

12. A computer program product comprising a non-transitory computer readable medium storing computer-executable components for causing a communication network to perform the method of claim 1 when the computer-executable components are run on processing circuitry comprised in the communication network.

13. A communication network comprising:
processing circuitry; and
storage storing instructions executable by said processing circuitry, wherein the communication network is operative to:
receive a trigger message indicating that a situation has occurred, the trigger message comprising situation specific information;
based on the received situation specific information, configure a service for handling the situation during a period of time until a predefined goal has been achieved, the service including a plurality of partially-ordered tasks to be performed and a plurality of stakeholders, the tasks being parameterized with entities and the stakeholders;
during the period of time, as part of the service, send updated information about the tasks to the stakeholders;
in response to the information sent, receive input about the tasks from the stakeholders; and
in response to the received input, automatically and dynamically reconfigure the service, including updating the information about the tasks, until the predefined goal has been achieved.

14. A computer program product comprising a non-transitory computer readable medium storing a computer program comprising computer program code which is able to, when run on processing circuitry of a communication network, cause the communication network to:
receive a trigger message indicating that a situation has occurred, the trigger message comprising situation specific information;
based on the received situation specific information, configure a service for handling the situation during a period of time until a predefined goal has been achieved, the service including a plurality of partially-ordered tasks to be performed and a plurality of stakeholders, the tasks being parameterized with entities and the stakeholders;
during the period of time, as part of the service, send updated information about the tasks to the stakeholders;
in response to the information sent, receive input about the tasks from the stakeholders; and
in response to the received input, automatically and dynamically reconfigure the service, including updating the information about the tasks, until the predefined goal has been achieved.

15. (canceled)
